(19) United States
(12) Patent Application Publication
(10) Pub. No.: US 2020/0389359 A1
(43) Pub. Date: Dec. 10, 2020

(54) UNIDIRECTIONAL LINK DETECTION MODE AUTO-DETECTION

(71) Applicant: HEWLETT PACKARD ENTERPRISE DEVELOPMENT LP, Houston, TX (US)

(72) Inventors: David Corrales Lopez, Heredia (CR); Andres Francisco Araya Rojas, Heredia (CR)

(21) Appl. No.: 16/435,869

(22) Filed: Jun. 10, 2019

(51) Int. Cl. H04L 12/24

(52) U.S. Cl. CPC H04L 41/0869; H04L 12/44; H04L 41/0806

(57) ABSTRACT

A network infrastructure device supporting communications on one or more network segments is provided, The network infrastructure device may perform an auto-mode detection for an appropriate unidirectional link detection (UDLD) protocol to be used between network neighbors of the network infrastructure device. The auto-mode detection may include a detection phase to detect a UDLD mode available within a network segment (e.g., supported by a pair of neighboring devices). A first UDLD mode from a set of supported UDLD modes for the network infrastructure device may be sent to neighboring devices; responses may be analyzed; and based on responses (or lack thereof) a mode may be selected, or other supported modes may be attempted, After negotiation, via the detection phase, and operational phase may be entered. A resultant network may have a network infrastructure device that concurrently supports different UDLD modes for different neighboring devices where each was automatically negotiated.

### BACKGROUND

Entities that have installed large local area networks typically have a multitude of network infrastructure devices connected to the network. These infrastructure devices are typically connected to form the network using many different physical connection methods. The network infrastructure devices may be devices such as switches or routers that are used to facilitate the connection of multiple devices to the network and allow data to flow between each connected device. Connected devices, such as laptop computers, tablets, or other network enabled devices, may communicate with other devices in the network through data exchange paths facilitated by the network infrastructure devices.

Networks are ideally wired to form a “bus” type topology that may be configured in a “ring,” “star,” “spine and leaf,” or another configuration. A bus topology, in this context, would be such that all devices on the network are wired in parallel to a single connection point that may allow a common interconnection among all devices. This “bus” topology, however, may not be feasible to implement in all cases and a network may be made up of several smaller segments that individually represent smaller bus segments joined together through interconnecting devices. One possible side effect of not being able to always implement a bus topology is that a network may form an unintended communication path where data may be unknowingly forwarded endlessly among several network infrastructure devices (e.g., undesirable loops may be formed). Some networks utilize a Spanning Tree Protocol (STP) to create logical networks inside the physical network to avoid such endless forwarding loops.

STP may rely on a bi-directional link between neighboring network infrastructure devices to be effective. A “neighboring network infrastructure device” in this context refers to network infrastructure devices adjacently connected together with a physical connection such as an Ethernet cable, a fiber optic cable, or any other connection mechanism available. That is, there are no intermediary devices between “neighboring” devices as they are directly connected to a common physical medium section. In some cases, a link between neighboring network infrastructure devices may become unidirectional (e.g. one side of the link may exclusively transmit or receive but not both), the forwarding loop may be inadvertently re-established. Unidirectional Link Detection (UDLD) protocol has several variations (e.g., modes) that may be used in conjunction with STP in an attempt to avoid any forwarding loops caused by unidirectional links. To work properly, both ends of a unidirectional link should utilize the same mode of UDLD.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not require serial processing and therefore may be performed in an order different than shown or possibly in parallel with each other. For a detailed description of various examples, reference will now be made to the accompanying drawings, in which:

FIG. 1 is a functional block diagram representing an example of a network infrastructure device such as a switch/router, according to one or more example implementations;

FIG. 2 is a functional block diagram representing an example of a high-availability switch, according to one or more example implementations;

FIG. 3A is an example of a local area network with multiple network infrastructure devices, according to one or more example implementations;

FIG. 3B is an example of a local area network to illustrate UDLD protocol detection of a multi-wire interconnection that has become unidirectional, according to one or more example implementations;

FIG. 4 is an example local area network segment including devices that understand a single variant of the UDLD protocol and other devices that understand multiple variants of the UDLD protocol such that they may work together to detect improper unidirectional loops within the network segment, according to one or more example implementations;

FIG. 5 is an example flow diagram for UDLD mode auto-detection, according to one or more example implementations;

FIG. 6 is an example computing device, with a hardware processor, and accessible machine-readable instructions stored on a machine-readable medium that may be used to implement the UDLD mode auto-detection, according to one or more example implementations;

FIG. 7 represents a computer network infrastructure that may be used to implement all or part of the disclosed automatic UDLD mode detection, according to one or more example implementations; and

FIG. 8 illustrates a computer processing device that may be used to implement the functions, modules, processing platforms, execution platforms, communication devices, and other methods and processes of this disclosure.

### DETAILED DESCRIPTION

Illustrative examples of the subject matter claimed below will now be disclosed. In the interest of clarity, not all features of an actual implementation are described for every example implementation in this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Today's networks may utilize a Spanning Tree Protocol (STP) to create logical networks inside the physical network to detect and avoid forwarding loops. A logical network, in this context, defines which physical interconnections to use when transmitting data between network infrastructure devices connected to the physical network (e.g., some physical ports on certain devices may be disabled). The logical network may optimize the use of physical network connections such that, for example, data transmitted between any network infrastructure devices traverses the shortest path. The logical network, in addition to utilizing the shortest path, may also avoid loops in a path. Loops are typically undesirable and affect network throughput, in part, because they may cause transmitted network data to be endlessly forwarded (e.g., traversing the loop) instead of being delivered to the intended destination device. In some cases, a network loop may cause failure of a network.

In general, STP utilizes a bi-directional link between neighboring network infrastructure devices to be effective. If the link between neighboring network infrastructure devices becomes unidirectional (e.g., one side of the link may exclusively transmit or receive but not both), a forwarding loop previously eliminated by STP may be inadvertently re-established. That is, as devices are added/removed from a network and components of a network experience failure, unintended loops may be created within a previously functioning network. The Unidirectional Link Detection (UDLD) protocol, used in conjunction with STP may avoid the forwarding loops from being re-established with unidirectional links. For the UDLD protocol to work effectively, all network infrastructure devices should be configured to utilize a consistent mode of UDLD protocol with all neighboring devices. In some networks, this would mean a consistent mode of UDLD protocol should be used throughout the entire network. However, it is possible that different network segments of a larger network may utilize different modes and still perform UDLD properly. In any case, auto-mode detection, as explained in this disclosure, may ensure that neighboring devices are consistent to each other with respect to UDLD mode. Accordingly, disclosed techniques represent an improvement for system and network administrators with respect to the art of system administration.

Different manufacturers (vendors) of network infrastructure devices may implement variations in their use of the UDLD protocol (as well as different configuration options). Thus, UDLD usage across different devices may not be compatible with network infrastructure devices produced by other manufacturers (or configured differently). These variations that may exist across differently configured devices are referred to herein as different “modes” of the UDLD protocol. Network infrastructure devices from the same manufacturer may also have the UDLD protocol options configured differently such that the UDLD protocol may not work effectively between neighboring network infrastructure devices. Further, network infrastructure devices (not having the benefit of disclosed techniques for auto-mode detection) may attempt to only communicate with neighboring devices with an expectation that all neighboring devices are configured for an identical UDLD mode. However, when neighboring network infrastructure devices are not configured with compatible UDLD protocol implementation and configuration options (not running in the same mode), the devices may not be able to effectively utilize the UDLD protocol and loop detection may be impacted (or non-existent) for a network segment.

According to disclosed techniques, a manufacturer of network infrastructure devices may implement devices that have the ability to utilize different variations and configurations of the UDLD protocol. That is, disclosed auto-mode detection may be used to implement a capability to understand different variations and configurations of the UDLD protocol. A “multi-protocol” network infrastructure device, as disclosed herein, may improve the maintainability of a local area network that is composed of a plurality of network infrastructure devices, in part, by having the ability to automatically adapt each device to work with other devices. That is, different devices may agree (automatically at run-time) on which of the disparate UDLD protocol modes to utilize for a network segment. In some disclosed implementations, a multi-protocol network infrastructure device may utilize a “detection phase” on startup where the multi-protocol network infrastructure device may not assume that neighboring network infrastructure devices are configured to utilize a specific UDLD mode. Instead, the multi-protocol network infrastructure device may attempt to discover the mode of UDLD utilized by neighboring network infrastructure devices to agree on a consistent mode at an “operational phase.”

According to some disclosed implementations, a network administrator may further configure the multi-protocol network infrastructure device to control the method in which the UDLD mode is detected. One configuration option, for example, may allow the network administrator to indicate the preferred UDLD mode to use between neighboring network infrastructure devices. Another example configuration may allow the network administrator to decide if a detection of protocol difference will block a link to a neighboring network infrastructure device instead of attempting to detect the appropriate UDLD mode to be used. Still further, the multi-protocol infrastructure device may also override configuration options when the UDLD protocol specification dictates how situations such as a protocol mismatch should be handled. In some UDLD protocol specifications, for example, a mismatch in UDLD protocol, leading to the inability for the network infrastructure devices to communicate using any UDLD protocol, indicates a link between the neighboring network infrastructure devices should be shut down (e.g., port disabled) until a network administrator manually intervenes and configures both devices to use or detect a matching UDLD protocol mode. For example, if a network administrator configured a multi-protocol network infrastructure device to keep a link enabled when a mismatch in UDLD protocol was detected but the preferred UDLD protocol standard indicates a contradictory reaction, some disclosed implementations may allow the multi-protocol network infrastructure device to override the network administrator's configuration settings.

The multi-protocol network infrastructure device, configured in accordance with this disclosure, may begin the detection phase by transmitting data, using a preferred UDLD protocol mode, to neighboring network infrastructure devices. A timer may be used to allow neighboring network infrastructure devices an opportunity to respond with data that indicates a UDLD protocol matching the preferred mode. The network administrator may also configure the multi-protocol network infrastructure device to attempt to adapt to a UDLD mode other than the preferred UDLD mode, for example, in a case where neighboring network infrastructure devices do not support the preferred UDLD mode. The network administrator may also add configuration options that determine if the detection phase infinitely attempts to establish a connection with a neighboring network infrastructure device. Specifically, the administrator may configure the multi-protocol network infrastructure device to continually cycle through all UDLD modes supported in a device (possibly repeatedly) until a UDLD connection is established with a neighboring network infrastructure device. The administrator may alternately set a time or attempt iteration limit that stops the detection phase and thus may cause the port to block due to the inability to establish UDLD protocol communication with a neighboring network infrastructure device.

In some implementations, a multi-protocol network infrastructure device may attempt to determine the UDLD mode supported by each neighboring network infrastructure device by inspecting the UDLD protocol data that was received from each respective neighboring network infrastructure device. The data inspected may include, for example, the media access control (MAC) address of the data packets received or any portion of the content of the received network data packets. The multi-protocol network infrastructure device may repeat the detection phase activities using the detected UDLD protocol with a timer that may define the time in which neighboring network infrastructure devices may indicate that they understand the UDLD mode used by the multi-protocol network infrastructure device. The multi-protocol network infrastructure device may repeat the detection phase using multiple variations of UDLD modes until the correct UDLD mode is consistent across all neighboring network infrastructure devices within a network segment. Once the multi-protocol network infrastructure device and any neighboring network infrastructure devices (which may include other multi-protocol network infrastructure devices) have established communications with a mutually supported UDLD mode, the multi-protocol network infrastructure device may enter into an “operational phase” where the UDLD mode is no longer negotiated.

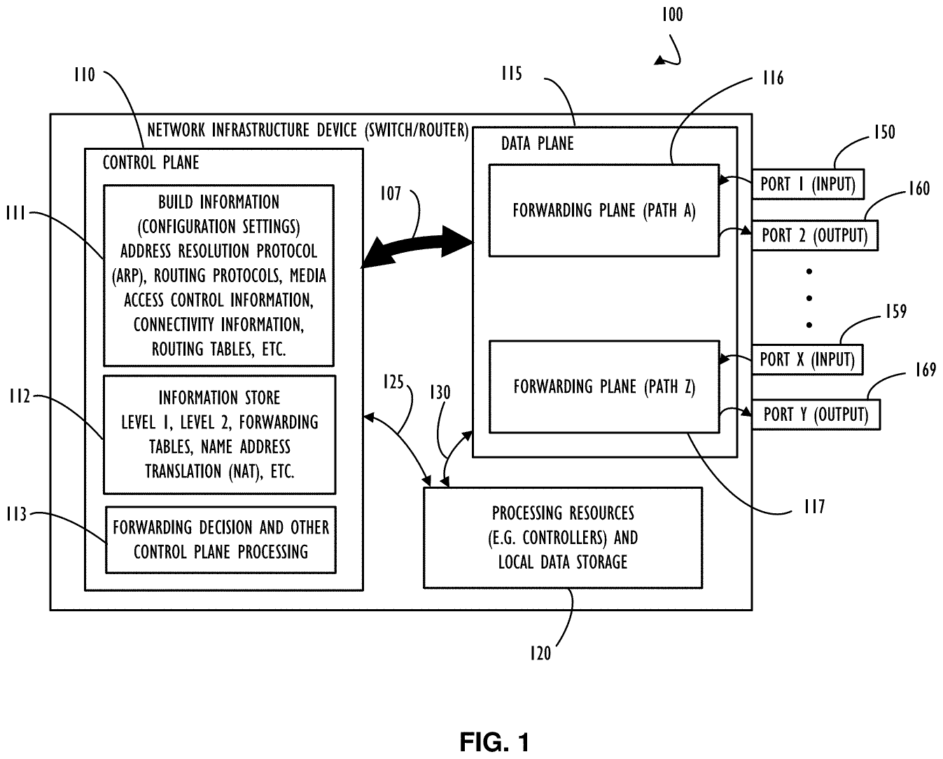

Referring now to FIG. 1, a network infrastructure device such as switch/router 100 is illustrated in a block diagram. In general, a switch/router 100 has two types of network element components organized onto separate planes illustrated as control plane 110 and data plane 115. In addition, a typical switch/router 100 may include processing resources and local data storage 120. Depending on the capabilities of a particular switch/router 100, different types of processing resources and local storage (for internal device usage) may be present. In general, higher capacity switch/router 100 implementations will include substantial processing resources and memory while simpler (e.g., low capacity) devices will contain less internal resources.

Control plane 110, for example, in a router may be used to maintain routing tables (or a single comprehensive routing table) that list which route should be used to forward a data packet, and through which physical interface connection (e.g., output ports 160 through 169). Control plane 110 may perform this function by using internal preconfigured directives, called static routes, or by learning routes dynamically using a routing protocol. Static and dynamic routes may be stored in one or more of the routing tables. The control-plane logic may then strip non-essential directives from the table and build a forwarding information base (FIB) to be used by data plane 115.

A router may also use a forwarding plane (e.g., part of the data plane 115) that contains different forwarding paths for information from different ports or different destination addresses (e.g., forwarding path A 116 or forwarding path Z 117). In general, switch/router 100 forwards data packets between incoming (e.g., ports 150-159) and outgoing interface connections (e.g., ports 160-159). Switch/router 100 forwards data packets to the correct network type using information that the packet header contains matched to entries in the FIB supplied by control plane 110. Ports are typically bidirectional and are shown in this example as either “input” or “output” to illustrate flow of a message through a routing path. In some network implementations, a router (e.g., switch/router 100) may have interfaces for different types of physical layer connections, such as copper cables, fiber optic, or wireless transmission. A single router may also support different network layer transmission standards. Each network interface may be used to enable data packets to be forwarded from one transmission system to another. Routers may also be used to connect two or more logical groups of computer devices known as subnets (or network segments), each with a different network prefix.

Also illustrated in FIG. 1, bidirectional arrow 107 indicates that control plane 110 and data plane 115 may work in a coordinated fashion to achieve the overall capabilities of switch/router 100. Similarly, bidirectional arrow 125 indicates that processing and local data storage resources 120 may interface with control plane 110 to provide processing and storage support for capabilities assigned to control plane 110. Bidirectional arrow 130 indicates that processing and local data storage resources 120 may also interface with data plane 115 as necessary.

Control plane 110, as illustrated in FIG. 1, includes several example functional control blocks. Additional control blocks are possible depending on the capabilities of a particular implementation of a switch/router 100. Block 111 indicates that control plane 110 may have associated build information regarding a software version of control code that is currently executing on switch/router 100. In addition, that software version may include configuration settings to determine how switch/router 100 and its associated control code perform different functions such as UDLD mode possibilities and their corresponding configuration options.

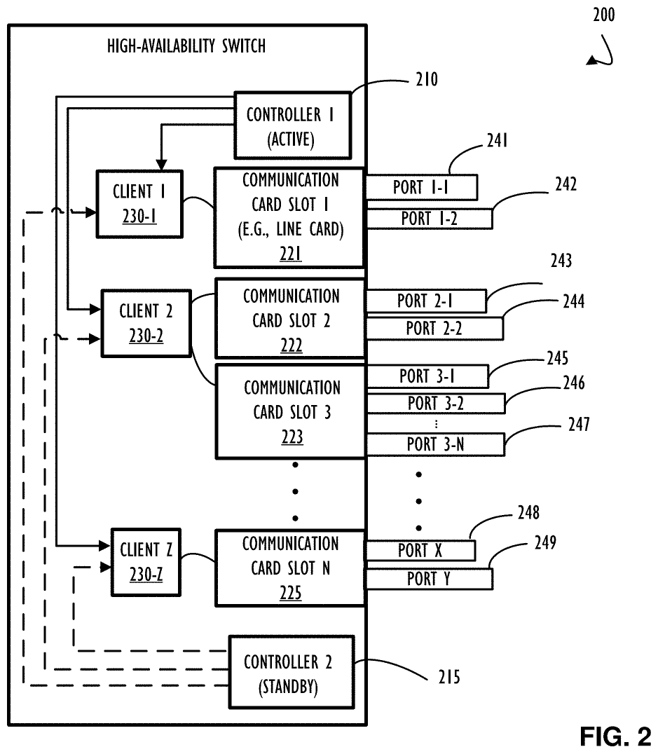

Many different configuration settings for both the software and the device itself are possible and describing each is beyond the scope of this disclosure. However, the disclosed automatic UDLD mode detection may be implemented in one or more functional sub-systems of switch/router 100. Also, as illustrated in FIG. 2, the network infrastructure device may be composed of multiple devices in a high-availability configuration. One or more devices in a single high-availability network infrastructure device configuration of a switch/router 100 may be used to implement the automatic UDLD mode detection.

Block 111 further indicates that different types of routing information and connectivity information may be known to switch/router 100 and control plane 110. Block 112 indicates that an information store may be accessible from control plane 110 and include forwarding tables or network address translation (NAT) information as appropriate. Block 111 indicates that control plane 110 may also be aware of forwarding decisions and other processing information. Although FIG. 1 illustrates these logical capabilities within control plane 110 they may actually be implemented outside of, but accessible to, control plane 110.

Referring now to FIG. 2, an example of a high-availability switch 200 is illustrated in a block diagram. High-availability switch 200 is illustrated with two controllers. Controller 1 (210) is identified as the “active” controller and Controller 2 (215) is identified as the “standby” controller. As explained in more detail below, a high-availability switch, such as high-availability switch 200, may have any number of controllers and typically has at least two. In some configurations, the controllers work as a primary/backup pair with a dedicated active controller and a dedicated standby controller. In a primary/backup configuration, the primary performs all network functions and the standby, as its name suggests, waits to become the active if a failover condition is reached. Failover may be automatic or manual and may cause initiation of a negotiation of UDLD mode on the upside of the failover. In general, failover at a high level refers to the active and standby switching roles so that the standby becomes the active and the active (typically after restarting) becomes the standby.

High-availability switch 200 also includes a plurality of communication cards (e.g., Card Slot 1 (221), Card Slot 2 (222), Card Slot 3 (223), and Card Slot N (225)) that may each have a plurality of communication ports configured to support network communication. A card slot, such as Card Slot 1 (221) may also be referred to as a “line card” and have a plurality of bi-directional communication ports (as well as a management port (not shown)). Card Slot 1 (221) is illustrated with port 1-1 (241) and port 1-2 (242) and may represent a “card” that is plugged into a slot (e.g., communication bus connection) of a backplane (e.g., communication bus) of high-availability switch 200. Other connections and connection types are also possible (e.g., cable connection, fiber optic). Also, in FIG. 2, Card Slot 2 (222) is illustrated with port 2-1 (243) and port 2-2 (244); Card Slot 3 (223) is illustrated with ports 3-1 (245), 3-2 (246), and port 3-N (247); and Card Slot N (225) is illustrated with port X (248) and port Y (249).

To support communications between a controller (e.g., an active and/or a standby controller) in a high-availability switch 200 and client devices connected to that high-availability switch 200, a number of communication client applications may be executing on a given high-availability switch 200. Client applications executing on high-availability switch 200 may assist in both communications to connected clients and configuration of hardware on the high-availability switch 200 (e.g., ports of a line card). In some cases, client applications are referred to as “listeners,” in part, because they “listen” for a communication or command and then process what they receive. For high-availability switch 200, an example client application is client 1 (230-1) which is illustrated to support communication from either the active or the standby controller to devices connected through Card Slot 1 (221). In some implementations a client application (e.g., client 1 (230-1)) may be used to perform or assist in performing UDLD mode negotiation. Disclosed implementations of UDLD mode negotiation (e.g., mode auto-detection) may be implemented in firmware, software, hardware logic, or a combination thereof.

A second example client application in FIG. 2 is client 2 (230-2) which is illustrated to support communication from either controller to both of Card Slot 2 (222) and Card Slot 3 (223). Finally, client Z (230-Z) is illustrated to support communication from both controllers to Card Slot N (225). Dashed lines are used the block diagram representing high-availability switch 200 that run from standby controller 2 to client applications as an indication that the standby controller may be communicatively coupled to a communication card slot via a client application but may not be transmitting significant data because of its standby status. In contrast, solid lines are used in the block diagram of high-availability switch 200 from active controller 1 to client applications to indicate an active status with likely more communication taking place. Also note that a single client may be configured to support more than one (or even part of one) communication Card Slot (line card) as illustrated with client 2 (230-2) supporting both of Card Slot 2 (222) and Card Slot 3 (223) concurrently. Upper limits on the number of card slots supported by a client may be an implementation decision based on performance characteristics or other factors of the switch and its internal design.

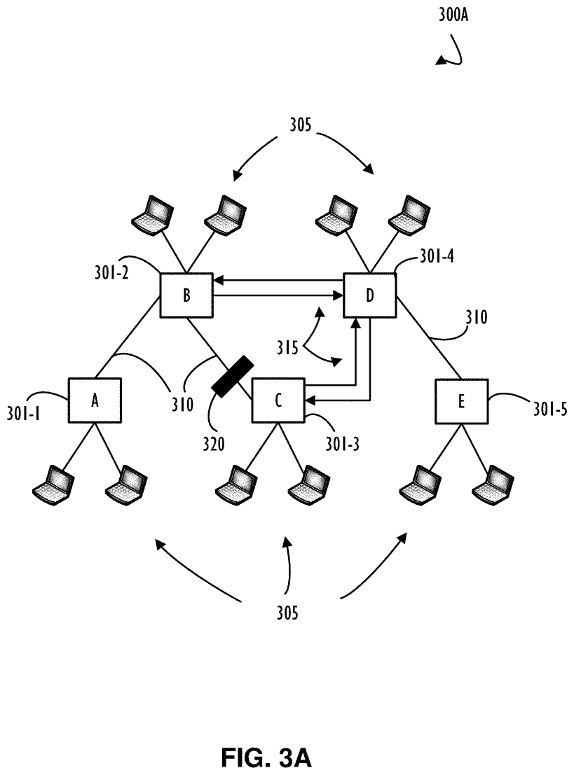

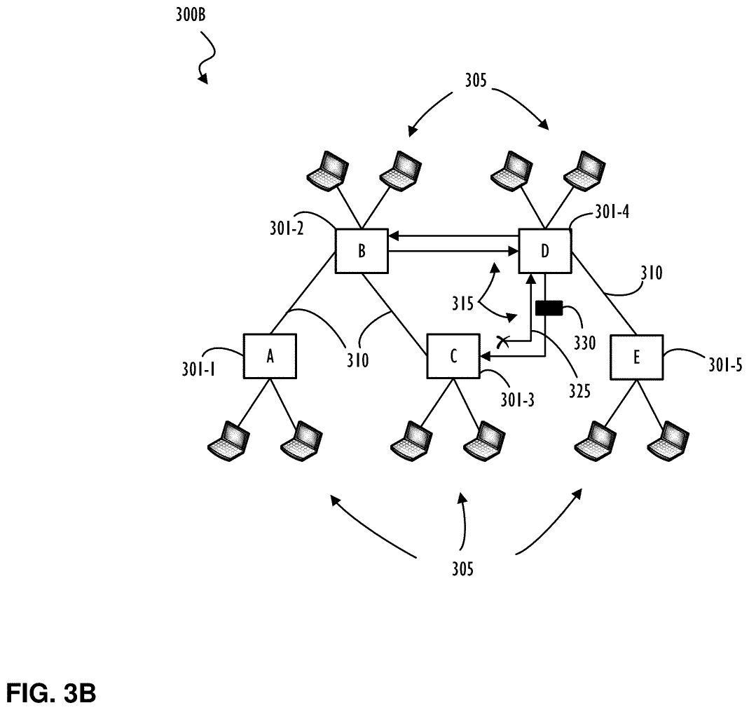

Referring now to FIG. 3A, an example of a local area network 300A with multiple network infrastructure devices 301-1 through 301-5 and client end-user devices 305 illustrated. Network infrastructure devices 301-1, 301-2, 301-3, 301-4, and 301-5 are illustrated with different physical interconnections for purposes of demonstrating how Spanning Tree Protocol (STP) may be complemented by the UDLD protocol with any type of physical network connections. To give a clear and complete illustration of a typical example of a local area network, a plurality of end-user devices 305 are illustrated as connected to each network infrastructure device. Because end-user devices 305 typically represent terminal nodes (sometimes referred to as edge devices or leaf nodes) within a network topology, UDLD protocol is not necessarily used on end-user devices 305. However, it is possible that one or more end-user devices 305 may be a dual-homed host (i.e., have multiple network interfaces and connections). In this situation it may be possible (and desirable) to perform loop detection on those devices in addition to other infrastructure devices. For simplicity of explanation that situation is not specifically discussed in this disclosure. However, those of ordinary skill in the art, given the benefit of this disclosure, will understand that such implementations are possible and may be performed in a similar manner to the examples of this disclosure.

In this example, single-wire interconnections 310 such as Ethernet, coaxial wire, or any other single-cable interconnections are illustrating interconnections between network infrastructure devices 301-1 & 301-2, 301-2 & 301-3, and 301-4 & 301-5 (each of network infrastructure devices 301-1 through 301-5 may be examples of network infrastructure device such as switch/router 100 as illustrated in FIG. 1 or high-availability switch 200 of FIG. 2). In this context, the term “single-cable” indicates that a single self-contained communication connection is used for the interconnection between devices. The term “single-wire” will also be used in this disclosure to have the same meaning as “single-cable” because details of the physical medium of the communication connection are not specifically pertinent to the disclosed UDLD mode detection. For example, the techniques of this disclosure are not limited to a physical wire in the case of a wireless communication channel. However, for simplicity a single-cable or single-wire terminology is used and may be considered for the purposes of this disclosure to be a communication path of a network. Additionally, a “single-cable” may be made of multiple components, such as may be observed with an Ethernet wire consisting of multiple strands of insulated copper wire twisted in pairs and combined as a single element to be held together by a surrounding insulator. Alternatively, the “single-cable” may be an optical medium or even a wireless connection representing a point-to-point connection between devices. To a user-device of the Ethernet wire, a single-cable logically appears to be one single “wire” though it may be internally composed of multiple wire strands (or multiple channels in the case of a wireless connection). These single-cable interconnections may allow bi-directional communication between the devices. A complete loss of inter-device communication may be lost should the single cable forming the interconnection between two devices break (or become unplugged).

In addition to single-cable connections, multi-wire interconnections 315 may be utilized. Example multi-wire interconnections 315 are illustrated by the interconnections between network infrastructure devices 301-2 & 301-4 and 301-4 & 301-3. In the multi-wire interconnections 315, each wire (again representing a communication channel and not necessarily a physical medium for transport) may serve the purpose of transmitting data in a single direction, as is indicated by the arrow ends on each element of a multi-wire interconnection 315. Multi-wire interconnections may be composed of any type of physical medium used for the interconnection, but a typical example would be where fiber optic wires are used for each element of the multi-wire interconnection. To be explicitly clear, the term “wire” in the context of the examples in this disclosure is used to refer to the physical link layer (layer 1) of the Open Systems Interconnect (OSI) network model used for interconnection and may also refer to a non-physical medium (i.e., in the case of wireless connections). While in some contexts a “wire” may refer to a physical medium that may be used to conduct low-voltage electricity to form signals, in the context of this disclosure it is used to explain any method of transmitting information in any form between two entities connected together by transmissions at layer 1 of the OSI model.

For purposes of the example of FIG. 3A, it is assumed all interconnections (310, 315) between network infrastructure devices (301-1 to 301-5) are fully operational with respect to their physical hardware. The network may be composed of a variety of network infrastructure devices 301-1 through 301-5 that may implement either a single UDLD mode or multiple UDLD modes. For example, network infrastructure device 301-4 may implement multiple UDLD modes that are different for connections to different neighboring devices. Each different connection typically is implemented using a different physical port of a switch or router. In this scenario, network infrastructure device 301-4 may implement a first UDLD mode for use with network infrastructure devices 301-2 and 301-3. In this example, network infrastructure devices 301-2 and 301-3 may only support a single UDLD mode. However, network infrastructure device 301-4 may support multiple UDLD modes on each of its different connections (e.g., ports). Thus, network infrastructure device 301-4 may establish a first UDLD mode for communications between 301-2 and 301-3 using one of the multiple UDLD modes that network infrastructure device 301-4 supports. Network infrastructure devices 301-2 and 301-3, that in one example implementation may support only one UDLD mode each, may implement the same UDLD mode as each other or may each implement a different UDLD mode that is still operable with network infrastructure device 301-4 because network infrastructure device 301-4 may support each different UDLD mode. Thus, a multi-protocol network infrastructure device, which in this example is network infrastructure device 301-4, may utilize a different UDLD mode for each interconnection to neighboring network infrastructure devices. Many combinations and permutations are possible but a single UDLD mode may be operational on a single interconnection at any one point in time.

Continuing with the example of FIG. 3A, a potential network connection loop may be observed between network infrastructure devices 301-2, 301-3, and 301-4. As this example assumes all interconnections between network infrastructure devices are fully operational, a port block 320 may be established, for example, through use of STP, to block the interconnection between network infrastructure devices 301-2 and 301-3 as shown. The port block 320 may be used to prevent data from being passed in an endless loop between network infrastructure devices 301-2, 301-3, and 301-4. In this example, STP has therefore formed a logical network utilizing a single interconnection between any pair of network infrastructure devices (301-1 to 301-5). Port block 320 may be implemented by blocking (disabling) a port on either (or both of) network infrastructure device 301-2 or network infrastructure device 301-3.

Referring now to FIG. 3B, shown is an example of a local area network 300B as a variation of local area network 300A. In the example of local area network 300B, the UDLD auto-mode detection techniques of this disclosure have detected that a multi-wire interconnection 315 has become unidirectional. In this example, the multi-wire interconnection 315 between network infrastructure devices 301-4 and 301-3 has become unidirectional when one leg of the interconnection 325 has broken (e.g., hardware failure of port, cable unplugged, wire damaged, etc.). Referring back to FIG. 3A, recall that use of STP had detected an interconnection loop between devices 301-2, 301-3, and 301-4 leading to the example port block 320 that prevented the use of the single-wire interconnection 310 between network infrastructure devices 301-2 and 301-3.

In FIG. 3B, the UDLD communication may have detected that the multi-wire interconnection 315 has one leg of the interconnection 325 broken to render the link between network infrastructure devices 301-4 and 301-3 unidirectional. STP, when used alone, may not detect this unidirectional link, but the use of the UDLD protocol may place a port block 330 on the working leg of the multi-wire interconnection 315 between network infrastructure devices 301-4 and 301-3. Further, STP may now indicate that removal of the port block 320 (referring to FIG. 3A) between network infrastructure devices 301-2 and 301-3 may be allowed so as to re-form the logical network (e.g., by re-establishing multi-wire connection 310 that was previously block by port block 320 of FIG. 3A) to maintain at least one communication path to every network infrastructure device (301-1 to 301-5).

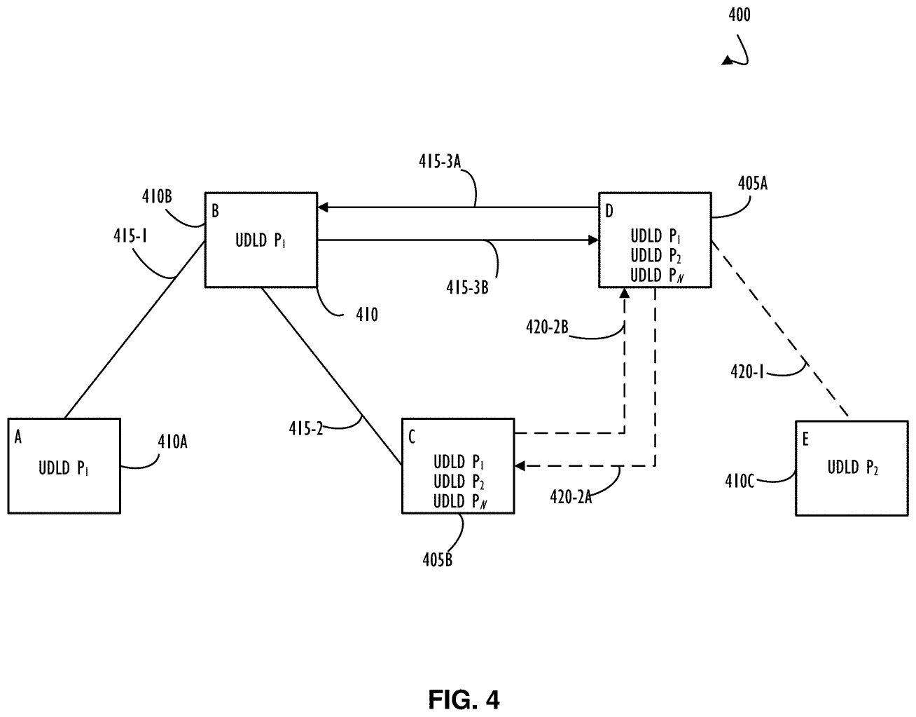

Referring to FIG. 4, shown is an example local area network 400 that includes several network infrastructure devices that are either a single-protocol device 410A-C or a multi-protocol device 405A-B. Example local area network 400 represents a variation to the networks of FIGS. 3A-3B where end-user devices 305 have been eliminated for simplicity. Each of these network infrastructure devices 410A-C and 405A-B represent examples of previously discussed network infrastructure device switch/router 100 of FIG. 1 or high-availability switch 200 and may have a single-wire interconnection 310 as discussed above for FIGS. 3A-B or a multi-wire interconnection 315 (also from FIGS. 3A-B) used as the interconnections to form the physical portion of local area network 400. These single-wire interconnections in local area network 400 include interconnection 415-1, interconnection 415-2, and interconnection 420-1 that are illustrated as having no directional arrows. Multi-wire interconnections include interconnection 415-3A, interconnection 415-3B, interconnection 420-2A, and interconnection 420-2B (where interconnection 415-3A and interconnection 415-3B work as a pair and interconnection 420-2A and interconnection 420-2B work as a pair). Multi-wire interconnections are illustrated as pairs of connections that have directional arrows. Not shown explicitly in this example is the logical network that may be created using STP and UDLD protocol. It is to be understood that a logical network with no improper loops may be formed using these protocols, but for brevity purposes the logical network will not be discussed in this example.

Network infrastructure devices in local area network 400 may be a device that is single-protocol (e.g., single-protocol device 410A, single-protocol device 410B, and single protocol device 410C) or may be a multi-protocol device (e.g., multi-protocol device 405A and 405B) with respect to supporting UDLD mode(s) (see discussion above). In this example, network infrastructure devices such as multi-protocol device 405A and multi-protocol device 405B may each start in a “detection phase” where they attempt to establish a connection to a neighboring network infrastructure device. The detection phase may include starting with a preferred UDLD mode but ultimately establishing communication using a single compatible UDLD mode for each inter-device connection between direct neighboring devices, In this example, the preferred UDLD mode may be Protocol 2 (e.g., UDLD P₂) that was previously selected (e.g., by a system administrator) and may be set as a configuration parameter of each respective device. Neighboring devices that support Protocol 2 may then establish UDLD connections using Protocol 2 (dashed line) as indicated by the interconnection 420A-B pair between multi-protocol device 405A and multi-protocol device 405B. In example local area network 400 Protocol 1 (UDLD P₁) is illustrated as a solid line for each applicable interconnection.

In this example, the detection phase that is performed by multi-protocol device 405A (and multi-protocol device 405B) may determine that some neighboring network infrastructure devices do not support the preferred mode. Specifically, multi-protocol device 405A may attempt to establish UDLD connections with each of the three neighboring devices: single-protocol device 410B, multi-protocol device 405B, and single-protocol device 410C based on different supported modes (e.g., multiple protocol/configuration combinations). Each supported mode may be attempted in the detection phase until a compatible UDLD protocol with each neighboring device is found. Device configuration options (e.g., as set by a system administrator) may indicate an order of preference for UDLD modes such that each mode is attempted based on the defined order of preference. In this example, solid multi-wire interconnection 415-3A and multi-wire interconnection 415-3B (that work as a pair) indicate that UDLD P₁ may be the negotiated UDLD mode to be used between multi-protocol device 405A and single-protocol device 410B. Similarly, the detection phase of multi-protocol device 405B may result in a UDLD P₁ mode (solid line) on single-wire interconnection 415-2 for single-protocol device 410B. UDLD P₂ is illustrated as the negotiated UDLD mode (interconnection 420-1) between multi-protocol device 405A and single-protocol device 410C. Finally, UDLD P₁ mode is illustrated as interconnection 415-1 between single-protocol device 410B and single-protocol device 410A. In this manner, where possible a preferred UDLD mode may be used and multiple UDLD modes may be automatically negotiated and selected using an auto-mode detection technique as discussed throughout this disclosure.

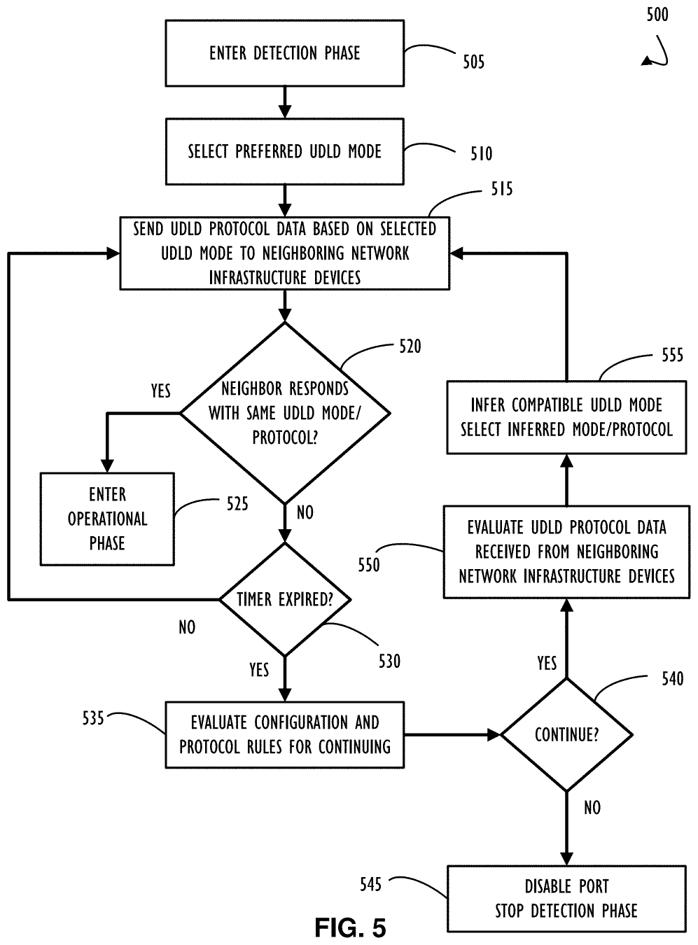

Referring to FIG. 5, shown is an example flow diagram for UDLD mode auto-detection illustrated as example method 500. As explained above, example method 500 may be used between devices to negotiate a UDLD mode that is supported by each device without system administrator intervention. Example method 500 for UDLD mode auto-detection begins at block 505 by a network infrastructure device, configured in accordance with this disclosure, entering the above-described detection phase. Flow continues to block 510 where the preferred UDLD mode may be selected (e.g., based on configuration parameters of a device) for the initial attempt to establish UDLD communications with neighboring network infrastructure devices, Continuing to block 515, the selected UDLD mode may indicate a UDLD protocol for data that may be transmitted (e.g., as a detection message) to neighboring network infrastructure devices to attempt to initiate UDLD communications with the selected UDLD mode. The “selected mode” in this context may be any UDLD protocol supported by a multi-protocol network infrastructure device. Continuing to decision 520, an evaluation may be performed to assess if a neighboring network infrastructure device has responded to indicate support of the selected UDLD mode. If the neighboring network infrastructure device does respond to indicate support of the selected UDLD mode (e.g., understood the UDLD protocol sent previously), flow continues to block 525 through the “YES” prong of the decision 520 and the network infrastructure device may enter an operational phase. Once in the operational phase, the device may not attempt to further negotiate the UDLD mode between one or more neighboring network infrastructure devices. However, an indication of a system restart, a network reconfiguration, or manual request may be provided to an infrastructure device to cause it to re-negotiate.

Returning to decision 520 for example method 500, if the evaluation determines that the neighboring network infrastructure device does not respond to indicate support of the selected UDLD mode (e.g., does not understand the protocol variation), flow continues to block 530 to evaluate if a configurable timer has expired for neighboring network infrastructure devices to respond to indicate support of the selected UDLD mode. If the timer has not expired, flow returns to block 515 through the “NO” prong of decision 530 where a retry of sending data may be performed or a recheck for response to previously sent data may be performed. Alternatively, if the timer has expired, flow continues to block 535 through the “YES” prong of decision 530. In block 535, an evaluation may be made to consider both configuration and protocol standard requirements to determine if the flow should continue to attempt to detect the UDLD mode supported by neighboring network infrastructure devices. This evaluation may include evaluating configuration options that limit the time window or number of retries to establish UDLD communication with a neighboring network infrastructure device.

After evaluation, flow continues to decision 540 where the need to continue supported UDLD protocol is determined. If the evaluation determines that the detection phase should not continue, flow continues to block 545 through the “NO” prong of decision 540 and the port connected to the neighboring network infrastructure device may be disabled. However, if the evaluation indicates that the detection phase should continue, flow continues to block 550 through the “YES” prong of decision 540. In block 550, data that was received from one or more neighboring network infrastructure devices (e.g., they may be in their own detection phase) may be evaluated to determine which UDLD mode to select so that the multi-protocol network infrastructure device may establish UDLD communication with the neighboring network infrastructure device using a supported mode of both devices. Flow continues to block 555 where the inferred mode of the UDLD protocol is selected and flow returns to block 515 where the detection phase continues with the newly selected UDLD mode. This process may be thought of as an overall negotiation between each network infrastructure device and all neighboring infrastructure devices where the negotiation order may be controlled by previously defined system administration configuration settings. As a result of the overall negotiation, devices may establish a network where supported UDLD modes are used as appropriate between devices such as the example described above for FIG. 4 where different UDLD modes were selected for different interconnections based on capabilities of each individual network infrastructure device.

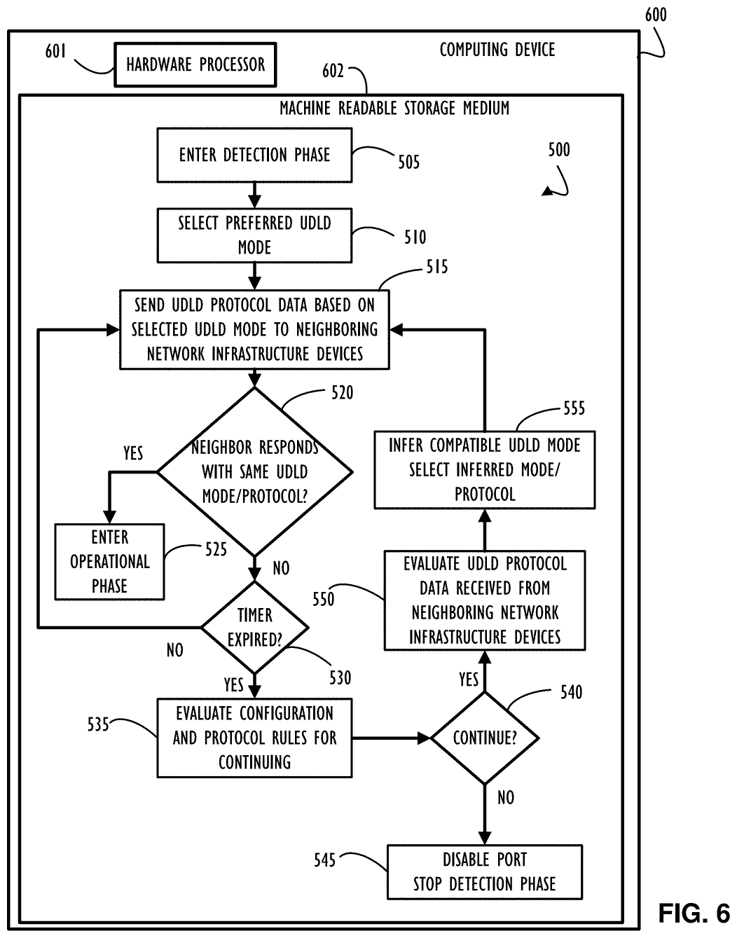

Referring to FIG. 6, shown is an example computing device 600, with a hardware processor 601, and accessible machine-readable instructions stored on a machine-readable medium 602 that may be used to implement the UDLD mode auto-detection techniques, according to one or more disclosed example implementations. FIG. 6 illustrates computing device 600 configured to perform the flow of method 500 as an example. However, computing device 600 may also be configured to perform the flow of other methods, techniques, functions, or processes described in this disclosure. In this example of FIG. 6, machine-readable storage medium 602 includes instructions to cause hardware processor 601 to perform blocks 505-555 discussed above with reference to FIG. 5.

A machine-readable storage medium, such as 602 of FIG. 6, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

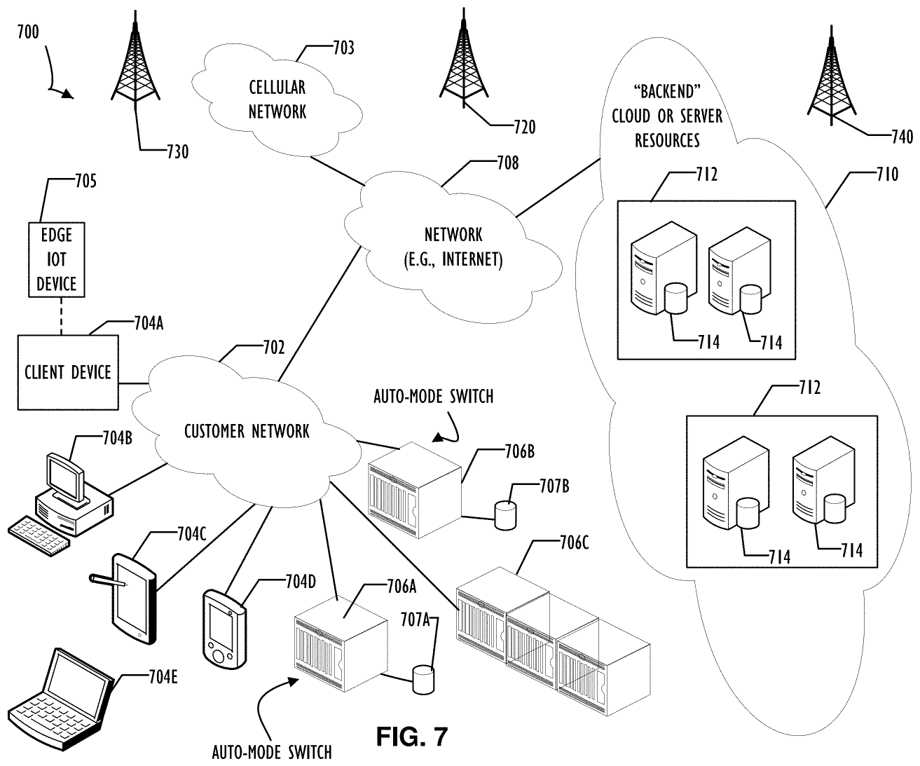

FIG. 7 represents a computer network infrastructure 700 that may be used to implement all or part of the disclosed automatic UDLD mode detection techniques, according to one or more disclosed implementations. Network infrastructure 700 includes a set of networks where implementations of the present disclosure may operate in one or more of the different networks. Network infrastructure 700 comprises a customer network 702, network 708, cellular network 703, and a cloud service provider network 710. In one implementation, the customer network 702 may be a local private network, such as local area network (LAN) that includes a variety of network devices that include, but are not limited to switches, servers, and routers.

Each of these networks may contain wired or wireless programmable devices and operate using any number of network protocols (e.g., TCP/IP) and connection technologies (e.g., WiFi® networks, or Bluetooth®. In another implementation, customer network 702 represents an enterprise network that could include or be communicatively coupled to one or more local area networks (LANs), virtual networks, data centers and/or other remote networks (e.g., 708, 710). In the context of the present disclosure, customer network 702 may include one or more high-availability switches or network devices using methods and techniques such as those described above (e.g., auto-mode switch 706A and auto-mode switch 706B).

As shown in FIG. 7, customer network 702 may be connected to one or more client devices 704A-E and allow the client devices 704A-E to communicate with each other and/or with cloud service provider network 710, via network 708 (e,g., Internet). Client devices 704A-E may be computing systems such as desktop computer 704B, tablet computer 704C, mobile phone 704D, laptop computer (shown as wireless) 704E, and/or other types of computing systems generically shown as client device 704A.

Network infrastructure 700 may also include other types of devices generally referred to as Internet of Things (IoT) (e.g., edge IOT device 705) that may be configured to send and receive information via a network to access cloud computing services or interact with a remote web browser application (e.g., to receive configuration information).

FIG. 7 also illustrates that customer network 702 includes local compute resources 706A-C that may include a server, access point, router, or other device configured to provide for local computational resources and/or facilitate communication amongst networks and devices. For example, local compute resources 706A-C may be one or more physical local hardware devices, such as the auto-mode network infrastructure devices outlined above. Local compute resources 706A-C may also facilitate communication between other external applications, data sources (e.g., 707A and 707B), and services, and customer network 702.

Network infrastructure 700 also includes cellular network 703 for use with mobile communication devices. Mobile cellular networks support mobile phones and many other types of mobile devices such as laptops etc. Mobile devices in network infrastructure 700 are illustrated as mobile phone 704D, laptop computer 704E, and tablet computer 704C. A mobile device such as mobile phone 704D may interact with one or more mobile provider networks as the mobile device moves, typically interacting with a plurality of mobile network towers 720, 730, and 740 for connecting to the cellular network 703.

FIG. 7 illustrates that customer network 702 is coupled to a network 708. Network 708 may include one or more computing networks available today, such as other LANs, wide area networks (WAN), the Internet, and/or other remote networks, in order to transfer data between client devices 704A-D and cloud service provider network 710. Each of the computing networks within network 708 may contain wired and/or wireless programmable devices that operate in the electrical and/or optical domain.

In FIG. 7, cloud service provider network 710 is illustrated as a remote network (e.g., a cloud network) that is able to communicate with client devices 704A-E via customer network 702 and network 708. The cloud service provider network 710 acts as a platform that provides additional computing resources to the client devices 704A-E and/or customer network 702. In one implementation, cloud service provider network 710 includes one or more data centers 712 with one or more server instances 714. Cloud service provider network 710 may also include one or more frames or clusters (and cluster groups) representing a scalable compute resource that may benefit from the techniques of this disclosure. Also, cloud service providers typically require near perfect uptime availability and may use the disclosed techniques, methods, and systems to provide that level of service.

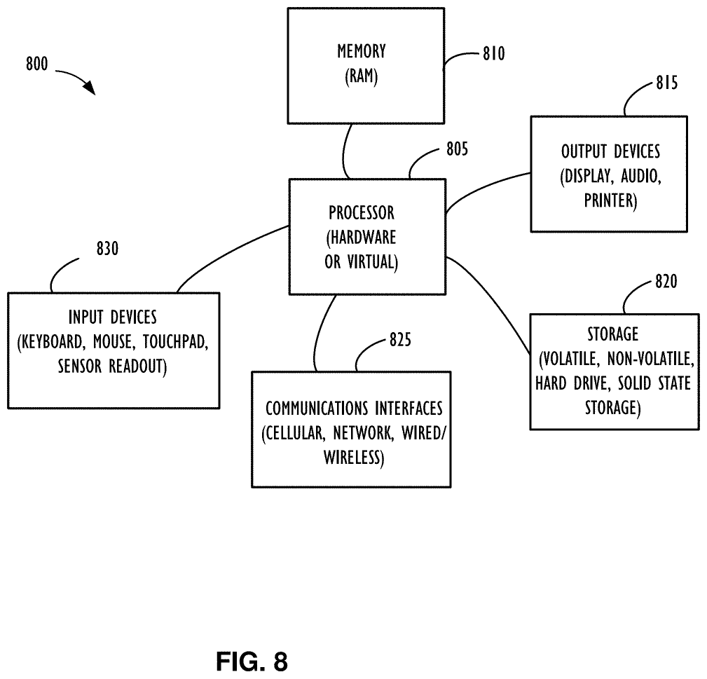

FIG. 8 illustrates a computing device 800 that may be used to implement or be used with the functions, modules, processing platforms, execution platforms, communication devices, and other methods and processes of this disclosure. For example, computing device 800 illustrated in FIG. 8 could represent a client device or a physical server device and include either hardware or virtual processor(s) depending on the level of abstraction of the computing device. In some instances (without abstraction), computing device 800 and its elements, as shown in FIG. 8, each relate to physical hardware. Alternatively, in some instances one, more, or all of the elements could be implemented using emulators or virtual machines as levels of abstraction. In any case, no matter how many levels of abstraction away from the physical hardware, computing device 800 at its lowest level may be implemented on physical hardware.

As also shown in FIG. 8, computing device 800 may include one or more input devices 830, such as a keyboard, mouse, touchpad, or sensor readout (e.g., biometric scanner) and one or more output devices 815, such as displays, speakers for audio, or printers. Some devices may be configured as input/output devices also (e.g., a network interface or touchscreen display).

Computing device 800 may also include communications interfaces 825, such as a network communication unit that could include a wired communication component and/or a wireless communications component, which may be communicatively coupled to processor 805. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 8, computing device 800 includes a processing element such as processor 805 that contains one or more hardware processors, where each hardware processor may have a single or multiple processor cores. In one implementation, the processor 805 may include at least one shared cache that stores data (e.g., computing instructions) that are utilized by one or more other components of processor 805. For example, the shared cache may be a locally cached data stored in a memory for faster access by components of the processing elements that make up processor 805. In one or more implementations, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 8, the processing elements that make up processor 805 may also include one or more of other types of hardware processing components, such as graphics processing units (GPU), application specific integrated circuits (ASICs), field-programmable gate arrays (FPGAs), and/or digital signal processors (DSPs).

FIG. 8 illustrates that memory 810 may be operatively and communicatively coupled to processor 805. Memory 810 may be a non-transitory medium configured to store various types of data. For example, memory 810 may include one or more storage devices 820 that comprise a non-volatile storage device and/or volatile memory. Volatile memory, such as random-access memory (RAM), can be any suitable non-permanent storage device. The non-volatile storage devices 820 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 820 may be used to store overflow data if allocated RAM is not large enough to hold all working data. The non-volatile storage devices 820 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 805. In one implementation, the compiling process of the software program may transform program code written in a programming language to another computer language such that the processor 805 is able to execute the programming code. For example, the compiling process of the software program may generate an executable program that provides encoded instructions (e.g., machine code instructions) for processor 805 to accomplish specific, non-generic, particular computing functions.

After the compiling process, the encoded instructions may then be loaded as computer executable instructions or process steps to processor 805 from storage device 820, from memory 810, and/or embedded within processor 805 (e.g., via a cache or on-board ROM). Processor 805 may be configured to execute the stored instructions or process steps in order to perform instructions or process steps to transform the computing device into a non-generic, particular, specially programmed machine or apparatus. Stored data, e,g., data stored by a storage device 820, may be accessed by processor 805 during the execution of computer executable instructions or process steps to instruct one or more components within the computing device 800.

A user interface (e.g., output devices 815 and input devices 830) can include a display, positional input device (such as a mouse, touchpad, touchscreen, or the like), keyboard, or other forms of user input and output devices. The user interface components may be communicatively coupled to processor 805. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 800 may comprise other components well known in the art, such as sensors, powers sources, and/or analog-to-digital converters, not explicitly shown in FIG. 8.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A network infrastructure device to manage inter-device communications on a first network, the network infrastructure device comprising:
a first plurality of network interface ports communicatively coupled to the first network;
a processing device to manage the first plurality of network interface ports; and
a non-transitory storage medium readable by the processing device and storing instructions, that when executed by the processing device, cause the network infrastructure device to:
perform a detection phase to determine a selected UDLD mode from a plurality of possible UDLD modes for each of the first plurality of network interface ports based, in part, on responses to one or more detection messages sent from the network interface device to each of a plurality of first network neighboring devices, wherein each of the plurality of first network neighboring devices represents a computing device connected, via the first network, to the network infrastructure device with no additional intervening devices on the first network that alter contents of network packets between the network infrastructure device and each instance of the plurality of first network neighboring devices;
detect a first response to a first detection message of the one or more detection messages, the first response received from a first neighboring device via a first network interface port of the first plurality of network interface ports;
analyze the first response to identify the selected UDLD mode for the first network interface port and the first neighboring device;
enter an operational phase using the selected UDLD mode for the first network interface port; and
utilize the selected UDLD mode for further UDLD protocol communications between the network infrastructure device and the first neighboring device.

2. The network infrastructure device of claim 1, wherein the instructions further comprise instructions to cause the network infrastructure device to:
detect a second response to a second detection message of the one or more detection messages, the second response received from a second neighboring device via a second network interface port of the first plurality of network interface ports;
analyze the second response to identify the selected UDLD mode for the second network interface port and the second neighboring device;
enter an operational phase using the selected UDLD mode for the second network interface port; and
utilize the selected UDLD mode for further UDLD protocol communications between the network infrastructure device and the second neighboring device.

3. The network infrastructure device of claim 2, wherein the selected UDLD mode for the second network interface port and the selected UDLD mode for the first network interface port are different UDLD modes.

4. The network infrastructure device of claim 3, wherein the first neighboring device is from a first hardware vendor and the second neighboring device is from a second hardware vendor different from the first hardware vendor.

5. The network infrastructure device of claim 2, wherein the selected UDLD mode for the second network interface port and the selected UDLD mode for the first network interface port are equivalent.

6. The network interface device of claim 1, wherein the network interface device further manages inter-device communications on a second network and further comprises:
a second plurality of network interface ports communicatively coupled to the second network, wherein the second plurality of network interface ports are managed by the processing device; and
the non-transitory storage medium further comprises instructions to cause the network infrastructure device to:
perform a detection phase to determine the selected UDLD mode from a plurality of possible UDLD modes for each of the second plurality of network interface ports based, in part, on responses to one or more detection messages sent from the network interface device to each of a plurality of second network neighboring devices, wherein each of the plurality of second network neighboring devices represents a computing device connected, via the second network, to the network infrastructure device with no additional intervening devices on the second network that alter contents of network packets between the network infrastructure device and each instance of the plurality of second network neighboring devices;
detect a second response to a second detection message of the one or more detection messages, the second response received from a second neighboring device via a second network interface port of the second plurality of network interface ports;
analyze the second response to identify the selected UDLD mode for the second network interface port and the second neighboring device;
enter an operational phase using the selected UDLD mode for the second network interface port; and
utilize the selected UDLD mode for further UDLD protocol communications between the network infrastructure device and the second neighboring device.

7. The network infrastructure device of claim 1, wherein the instructions further comprise instructions to cause the network infrastructure device to:
send an initial detection message as the first detection message, the initial detection message using a designated preferred UDLD mode based on a configuration setting of the network infrastructure device.

8. The network infrastructure device of claim 7, wherein the instructions further comprise instructions to cause the network infrastructure device to:
wait a pre-determined period for responses to the initial detection message; and
based on a lack of the first response within the pre-determined period, send an additional detection message of the one or more detection messages, the additional detection message using an inferred UDLD mode, the inferred UDLD mode based on network packets received from at least one of the pluralities of first network neighboring devices during the pre-determined period.

9. The network infrastructure device of claim 8, wherein the at least one of the plurality of first network neighboring devices includes the first neighboring device.

10. The network infrastructure device of claim 7, wherein the instructions further comprise instructions to cause the network infrastructure device to:
wait a pre-determined period for responses to the initial detection message; and
based on a lack of the first response within the pre-determined period, send an additional detection message of the one or more detection messages, the additional detection message using an additional UDLD mode, the additional UDLD mode based on supported UDLD modes of the network infrastructure device and different from the preferred UDLD mode.

11. The network infrastructure device of claim 10, wherein all supported UDLD modes of the network infrastructure device are attempted to complete the detection phase.

12. The network infrastructure device of claim 11, wherein the instructions further comprise instructions to cause the network infrastructure device to:
determine completion of the detection phase; and
based on a lack of response to all attempted detection messages, disable the first network interface port.

13. A method, comprising:
entering a detection phase, at a network infrastructure device, to detect a unidirectional link detection (UDLD) mode available within a network segment;
selecting a first UDLD mode from a set of supported UDLD modes for the network infrastructure device;
sending a first UDLD message based on the first UDLD mode to neighboring devices of the network infrastructure device within the network segment;
based upon receiving a first response to the first UDLD message from a first neighboring device, entering an operational phase of UDLD using the first UDLD mode for UDLD communications between the network infrastructure device and the first neighboring device;
based upon lack of receipt of the first response within a predetermined time period, remaining in the detection phase and sending a second UDLD message based on a second UDLD mode, from the set of supported UDLD modes for the network infrastructure device, to the first neighboring device; and
based upon receiving a second response to the second message from the first neighboring device, entering the operational phase of UDLD using the second UDLD mode for UDLD communications between the network infrastructure device and the first neighboring device.

14. The method of claim 13, wherein based upon lack of receipt of the second response at the network infrastructure device, disabling a port of the network infrastructure device used to send the first UDLD message and the second UDLD message.

15. The method of claim 13, further comprising:
based upon receiving a first response to the first UDLD message from a second neighboring device, entering an operational phase of UDLD using the first UDLD mode for UDLD communications between the network infrastructure device and the second neighboring device.

16. The method of claim 15, wherein the first UDLD mode is used for UDLD communications between the network infrastructure device and the second neighboring device and the second UDLD mode is used for UDLD communications between the network infrastructure device and the first neighboring device.

17. The method of claim 16, wherein the first neighboring device is from a first hardware vendor and the second neighboring device is from a second hardware vendor different from the first hardware vendor.

18. A non-transitory computer readable medium comprising instructions stored thereon that, when executed by a processor of a network infrastructure device, cause the network infrastructure device to:
enter a detection phase, at the network infrastructure device, to detect a unidirectional link detection (UDLD) mode available within a network segment;
select a first UDLD mode from a set of supported UDLD modes for the network infrastructure device;
send a first UDLD message based on the first UDLD mode to neighboring devices of the network infrastructure device within the network segment;
based upon receiving a first response to the first UDLD message from a first neighboring device, enter an operational phase of UDLD using the first UDLD mode for UDLD communications between the network infrastructure device and the first neighboring device;
based upon lack of receipt of the first response within a predetermined time period, remain in the detection phase and sending a second UDLD message based on a second UDLD mode, from the set of supported UDLD modes for the network infrastructure device, to the first neighboring device; and
based upon receiving a second response to the second message from the first neighboring device, enter the operational phase of UDLD using the second UDLD mode for UDLD communications between the network infrastructure device and the first neighboring device.

19. The non-transitory computer readable medium of claim 18, further comprising instructions to cause the network infrastructure device to:
based upon receiving a first response to the first UDLD message from a second neighboring device, enter an operational phase of UDLD using the first UDLD mode for UDLD communications between the network infrastructure device and the second neighboring device.

20. The non-transitory computer readable medium of claim 19, wherein the network infrastructure device concurrently utilizes first UDLD mode for UDLD communications between the network infrastructure device and the second neighboring device and the second UDLD mode for UDLD communications between the network infrastructure device and the first neighboring device.
